(19) United States
(12) Patent Application Publication
(10) Pub. No.: US 2012/0057537 A1
(43) Pub. Date: Mar. 8, 2012

(54) METHOD AND DEVICE FOR CONDITIONAL ACCESS

(76) Inventors: Brett SCHEIN, San Jose, CA (US); Murari Srinivasan, Palo Alto, CA (US); James Michael Murphy, Santa Clara, CA (US)

(21) Appl. No.: 13/211,003

(22) Filed: Aug. 16, 2011

Related U.S. Application Data
(60) Provisional application No. 61/380,057, filed on Sep. 3, 2010.

(51) Int. Cl. H04W 72/04

(52) U.S. Cl. 370/329

(57) ABSTRACT

Methods, devices, and computer program products facilitate access to, and usage of resources within, a radio network. A conditional access framework incorporates myriad technologies ranging from authentication, session control, Internet Protocol (IP) packet inspection to resource allocation by airlink schedulers. Such an end-to-end control enables effective implementation of conditional access paradigms by ensuring service guarantees for authorized users while resulting in a certain level of service availability to guest users.

### CROSS REFERENCE TO RELATED APPLICATION(S)

The present application claims priority to U.S. Provisional Patent Application Ser. No. 61/380,057, titled “METHOD AND DEVICE FOR CONDITIONAL ACCESS,” filed on Sep. 3, 2010, the entirety of which is hereby incorporated by reference.

### FIELD OF INVENTION

The present invention relates generally to the field of wireless communications. More particularly, the present invention relates to facilitating access to a wireless network resources.

### BACKGROUND OF THE INVENTION

This section is intended to provide a background or context to the disclosed embodiments that are recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Conventional licensed-spectrum cellular systems use an access-control list that is placed on a Home Location Register (HLR) within the core network to authenticate subscribers that are allowed to access the network. As local-area cellular wireless systems get deployed, leading to hierarchical network topologies, the access-control mechanism gets more complicated. Consumer femtocells typically use a Closed Subscriber Group (CSG) paradigm, in which a limited set of users is allowed access to that cell, and everyone else is rejected. The CSG paradigm effectively leads to a small coverage hole created in the middle of the wide-area macrocellular network.

In other cases where local-area networks are deployed in a spectrum that is distinct from the wide-area macro network, coverage-hole limitations may not be present. However, in these scenarios, the use of the local-area networks resources may still be desirable to supplement the overall network capacity and to improve user experiences. However, access to the local-area resources would still require proper access-control considerations and policies.

### SUMMARY OF THE DISCLOSURE

The disclosed embodiments relate to methods, devices, and computer program products that facilitate access to, and usage of resources within, a radio network. One aspect of the disclosed embodiments relates to a method that comprises assigning weights to a plurality users of a radio network, where each of the plurality of users are categorized within one of a plurality of classes. The method further includes allocating radio network resources to a user pursuant to the weight associated with the user. In one embodiment, the radio network is configured within a larger radio network and the plurality of users comprise one or more users of the larger radio network that are unknown to the radio network. In this embodiment, the one or more users of the larger radio network request one or more services from the radio network.

In one embodiment, the plurality of classes comprise an authorized class of users with a preferential level of radio network service. In such a scenario, a user within the authorized class of users is identified in accordance with an identifier within an internet protocol (IP) packet associated with a user within the authorized class of users. In another embodiment, the plurality of classes comprise a guest class of users with a conditional level of radio network service. In one embodiment, a weight is assigned to each individual user of the radio network, while in another embodiment, a weight is assigned to each group of users of the radio network within a particular class. In still another embodiment, a weight is assigned to each class of users of the radio network.

According to another embodiment, radio network resources are allocated in proportion to the assigned weights. For example, the radio network resources can include a bandwidth, a time slot, a carrier frequency or a transmission power associated with the radio network. In another embodiment, allocating the radio network resources include selecting a class of users and allocating radio network resources to a plurality of users within the selected class. In one embodiment, the selection of the class of users is carried out in accordance with a probability value. In another embodiment, the selection of the class of users is carried out deterministically in accordance with a number of classes and weights associated with the plurality of classes.

In still another embodiment, the selection of the class of users is carried out in accordance with a history of previously selected user classes. Another embodiment further includes determining if additional radio network resources are available, selecting a different class of users, and allocating radio network resources to a plurality of users within the different class of users. The above described method can further comprise setting a maximum level of radio network resources consumed by at least one user of the radio network. For example, the maximum level of radio network resources can include a maximum data rate.

According to another embodiment, the above described method can further comprise controlling admission to the radio network pursuant to the assigned weights. In one embodiment, the above described method further comprises modifying an allocated radio network resource to an authorized user by changing a weight associated with the authorized user when the authorized user is in communication with one or more radio nodes. In another embodiment, the above noted method comprises modifying, on a per-radio-node basis, an allocated radio network resource to a particular class of users by changing a weight associated with the particular class of users when the particular class of users are communicating through one or more radio nodes. For example, the one or more radio nodes can designate a particular geographic location. In another embodiment, allocating the radio network resources is carried out pursuant to the number of additional users within the radio network. In this embodiment, the user of the radio network is an authorized user of the radio network and the additional users of the radio network are guest users of the radio network. According to another embodiment, the above described method further comprises configuring a list of users associated with at least one of the plurality of classes, where a user within the configured list is identified in accordance with a unique identifier. In one example, the unique identifier is an international mobile subscriber identity (IMSI).

Another aspect of the disclosed embodiments relate to a device that comprises a processor and a memory that includes processor executable code. The processor executable code, when executed by the processor, configures the apparatus to assign weights to a plurality users of a radio network, where each of the plurality of users is categorized within one of a plurality. The processor executable code, when executed by the processor, further configures the apparatus to allocate radio network resources to a user pursuant to the weight associated with the user.

Another aspect of the disclosed embodiments relate to a computer program product, embodied on a computer readable medium. The computer program product comprises program code for assigning weights to a plurality users of a radio network, where each of the plurality of users is categorized within one of a plurality of classes. The computer program product further comprises program code for allocating radio network resources to a user pursuant to the weight associated with the user.

These and other advantages and features of various embodiments of the present invention, together with the organization and manner of operation thereof, will become apparent from the following detailed description when taken in conjunction with the accompanying drawings.

### BRIEF DESCRIPTION OF THE DRAWINGS

Embodiments of the invention are described by referring to the attached drawings, in which:

FIG. 1 illustrates a radio network for use with the disclosed embodiments;

FIG. 2 is a block diagram illustrating data and signal scheduling in accordance with an example embodiment;

FIG. 3 is a block diagram illustrating a user class selection in accordance with an example embodiment;

FIG. 4 is a block diagram illustrating a user class selection in accordance with another example embodiment;

FIG. 5 is a block diagram illustrating data scheduling in accordance with an example embodiment; and

FIG. 6 is a block diagram of an example device for implementing the various disclosed embodiments.

### DETAILED DESCRIPTION OF CERTAIN EMBODIMENTS

In the following description, for purposes of explanation and not limitation, details and descriptions are set forth in order to provide a thorough understanding of the disclosed embodiments. However, it will be apparent to those skilled in the art that the present invention may be practiced in other embodiments that depart from these details and descriptions.

Additionally, in the subject description, the word “exemplary” is used to mean serving as an example, instance, or illustration. Any embodiment or design described herein as “exemplary” is not necessarily to be construed as preferred or advantageous over other embodiments or designs. Rather, use of the word exemplary is intended to present concepts in a concrete manner.

The disclosed embodiments facilitate access to a various network resources in situations where a CSG paradigm is not applicable. For example, the disclosed embodiments can be implemented as part of wireless systems that are designed to be deployed in larger extents, such as enterprises, campuses, airports, stadiums and the like. In these scenarios creating a strict access-control list, as provided in a CSG paradigm, is infeasible. In particular, subscribers of the wide-area macrocellular network need to be allowed access to this local-area network (e.g., the femtocell). A failure to access the local-area network can thus be construed as coverage hole within the larger network and/or a denial-of-service scenario. In other scenarios, access to the local-area network resources may be desirable to supplement the resources available to a user with present connectivity to a radio network. Allowing a fully Open Subscriber Group (OSG), where access to the network resources is readily available to all users, is also impractical. The reason for this is that the stakeholders interested in local-area deployments, such as an enterprise or campus owner, would like to ensure that a certain amount of bandwidth is always made available for authorized users, such as employees of the enterprise. This ensures that bandwidth demands of guest or non-authorized users do not swamp the system, and that the authorized users are able to get certain service guarantees. At the same time, unlike the CSG framework, the OSG approach does not result in denial of service to non-authorized users.

According to the disclosed embodiments, a conditional access framework is provided that overcomes the above-noted deficiencies associated with the CSG and OSG paradigms. The conditional access framework that is described in connection with the disclosed embodiments incorporates myriad technologies ranging from authentication, session control, Internet Protocol (IP) packet inspection to resource allocation by airlink schedulers. Such and end-to-end control enables effective implementation of conditional access paradigms in accordance with the disclosed embodiments by ensuring service guarantees for particular users while resulting in a certain level of service availability to other users that avoids denial-of-service scenarios.

In one embodiment, the users of a radio network may be categorized into two or more types of users. The users can be identified via a unique identifier associated with their subscriber identity modules (SIM) and/or their IP addresses. In one example, the traffic associated with the users of the radio network may be classified into two user classes of service (CoS) by a session manager based on the user identity and the policy configuration for that user. In particular, the users may be categorized as authorized users that are entitled to a preferential level of service, and guest users that include any user that is not an authorized user. The two or more classes of users are entitled to different levels of service and/or access to the resources within the local network. The guest users can, for example, include roaming users that are attempting to transition to acquire service outside of their “home network.” It should be noted that in one example scenario, the home network of a guest user is the macro network. In this context, a visitor to the enterprise network may acquire services within the enterprise radio network as a guest user.

The disclosed embodiments provide conditional access for the users by facilitating service provision to the guest users while providing preferential service to the authorized users of the enterprise network. Similarly, when more than two classes of users are identified, the provision of services can be divided among the multiplicity of user groups according to a given policy. For example, the policy can provide for allocation of resources among the different users. Such resources include, but are not limited to, power, time, spectrum, bandwidth and the like. The preferential treatment for particular classes of users may be furthered within the wireline packet transport areas of the radio networks that can accommodate the disclosed embodiments. For example, a downlink IP packet of an authorized user may be stamped by the controller of the radio network with a marking that provides the authorized user with preferential treatment over a guest user's packet between the controller and an access point. Similarly, in uplink transmissions, an access point may stamp the uplink IP packet of an authorized user with a marking that gives that authorized user preferential treatment over a guest user's packet between the access point and the controller.

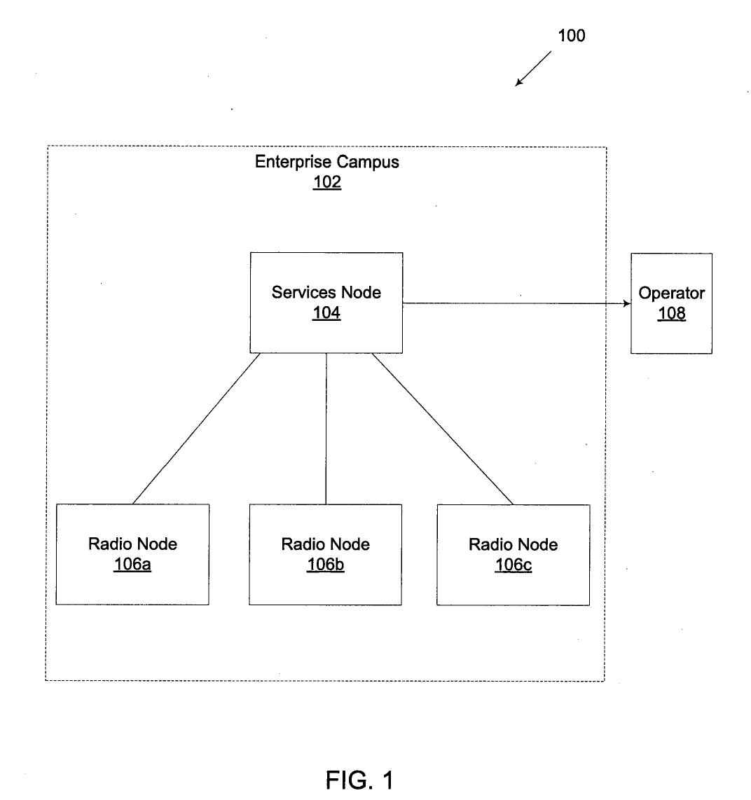

Some of the disclosed embodiments leverage the Class of Service (CoS) and other available mechanisms and are, therefore, distributed across the Services Node (SN) and the individual Radio Nodes (RNs). FIG. 1 illustrates an exemplary Enterprise Radio Access Network (E-RAN) 100 comprising a services node 104 and a plurality of radio nodes 106a to 106c that can used for implementation of the disclosed embodiments. It should be noted that the E-RAN 100 can include fewer or additional radio nodes and/or additional services nodes. The services node 104 is the central control point of the overall cluster of radio nodes 106a to 106c that are deployed throughout the enterprise campus 102. The services node 104, which can be deployed inside the enterprise local area network (LAN) provides, for example, session management for all mobile sessions delivered by the radio nodes 106a to 106c. The radio nodes 106a to 106c can support a multi-radio architecture that allows a flexible upgrade path to higher user counts as well as the ability to support different radio access technologies. In one example, the E-RAN 100 configuration allows the creation of a unified mobile corporate network that integrates mobile workers distributed throughout the overall enterprise domain with centrally located corporate assets. FIG. 1 also illustrates an operator 108 that is in communication with the services node 104, can monitor the operations of the services node 104 and can provide various input and control parameters to the services node 104. The interactivity between the operator 108 and the services node 104 can be provided through, for example, a command line interface (CLI) and/or industry-standard device configuration standards, such as TR-69 or TR-169.

It should be noted that the disclosed embodiments are equally applicable to non-centralized network architectures. Such architectures can, for example, comprise isolated home nodes and/or radio nodes or a femtocell-based enterprise deployments that do not use a central controller.

According to the disclosed embodiments packet-switched (PS) traffic within a network may be categorized into two or more classes. For example, the traffic associated with the authorized and guest users may be treated as two separate classes. In one embodiment, all traffic that is not authenticated by the core authentication, authorization and accounting (AAA) sever is automatically dropped and, therefore, is not subject to further operations. In another embodiment, the authorized and guest user traffic may be separated through Internet Protocol (IP) differentiated services code point (DSCP) tags. For example, for downlink (DL) PS data, the CoS may be encoded in the packet header via the IP DSCP and sent to a radio node. At the radio node, the CoS is propagated to a controller within the radio node along with the data packet and used to schedule the packet for transmission over the air. The above-noted example represent one exemplary delivery mechanism for the CoS. However, it is understood that the CoS may be communicated using a variety of other techniques. For example, a user packet, which may be an IP packet, can be encapsulated in another IP layer for communication between a services node and a radio node and/or among various radio nodes. In these example scenarios, the outer IP layer may contain the CoS value in its DSCP field. The original user packet, however, may or may not be changed before encapsulation and communication between nodes of the network. In yet another example, the default CoS can be communicated between the nodes with a separate and explicit message. For example, a particular radio node may be configured using a radio link configuration message that includes the user (default) CoS as part of the configuration message. Such communications can take place between a controller node (e.g. a services node 104) and various radio nodes or, alternatively, among the nodes of a non-centralized radio network.

In one embodiment, the scheduling and transmission of data is carried out in accordance with weights that are associated with each class of users. In particular, resource allocation weights can be assigned to each user class. The specific weights for each class of users may be assigned according to a usage policy that is determined by system administrators, designers of the network and/or owners or stakeholders of the network. In addition, the weights assigned to each class of users may be modified as necessitated by new usage policies and/or network demands. In one example, using a CLI and/or a TR client, an operator may set the resource allocation weights assigned to each user class. These weights are associated with the proportion (e.g., a particular percentage) of airlink resources that are reserved for each user class traffic. In another example, where user traffic is categorized as authorized and guest user traffic, the relative weights for the authorized and guest users can be equal to, or derived from, the weighted round robin (WRR) weights configured for all the assured forwarding (AF) classes and the best effort (BE) classes, respectively. For example, a AF1 weight of 30 and a BE weight of 5 produce normalized relative weights of approximately 85% and 15%, respectively. The weights for AF1 and BE can be tuned to achieve weights desired by the customer.

In another embodiment, the scheduling and transmission of data is carried out in accordance with weights that are associated with each user within a class of service. The specific weights for each user may be assigned according to a usage policy that is determined by system administrators, designers of the network and/or owners or stakeholders of the network. In one example, each authorized user is allocated the same amount of network resources as any other authorized user. Similarly, each guest user is allocated the same amount of network resources as any other guest user of the network. This exemplary assignment of weights to the different users can be further illustrated by assuming that there is a single policy specified for authorized users, where the authorized user policy has an associated weight. In this scenario, every authorized user, which can be identified by, for example, an international mobile subscriber identity (IMSI), is pointed to that policy and, therefore, inherits the assigned weight. It should be noted than the user communicates its IMSI to the network upon establishing a connection with the network. Similarly, a default policy can be specified for guest users, which includes an associated weight. An unknown (e.g., guest) user is pointed to that policy and, therefore, inherits the assigned weight. As a result, every authorized user is allocated the same amount of resources as every other authorized user and every guest user is allocated the same amount of resources as every other guest user.

This approach, when compared to the previously described assignment of a “class weight” to each user class, can create a situation where a large number of guest users yields a small throughput for a single authorized user. For example, let's assume that the weight associated with each authorized user is 5 and the weight associated with each guest user is 1. If there are 100 guest users and one authorized user, the authorized user is allocated 5/105 of the total resources, while each guest user gets 1/105 of the total resources. In such situations, however, it may be preferable to ensure that a certain percentage of resources are always made available to the authorized users, regardless of the number of guest users. In still other embodiments, the weights can be assigned to a group of users (i.e., a subset of users within a class) of the radio network.

Additionally, the reserved resources can be guaranteed for the associated user and/or user class when there is sufficient traffic to consume them. If there is not sufficient traffic to consume the reserved resources, then the resources may be freed up to accommodate traffic associated with other users and/or user classes. In one example, the reserved resources represent a reserved bandwidth (e.g., bitrate) associated with one or more classes of users, while in another example, the reserved airlink resources represent a reserved time associated with one or more classes of users. As such, the airlink resources may be partitioned into a plurality of times, bitrates or a combination thereof. Other examples of resources include power (e.g., transmit power), spectral range, number of frequency carriers and other resources that may be used to effect airlink transmissions.

In another example, the weights associated with airlink resource partitions for each class of users can be provided in a template that is applied (e.g., by default) to all radio nodes. In this scenario, an operator may override the default weights per individual radio node basis. In a further example, the operator can disable the partitioning of airlink resources. This disabling may be carried out for all radio nodes at once and/or for individual radio nodes. In one particular example scenario, when radio resource partition is disabled, the same airlink scheduling policy may be applied equally to all classes of users. The above-noted disabling option provides a separate mechanism for controlling the allocation of resources that can be implemented quickly and efficiently. For example, such a portioning may be carried out on a timescale of 1 minute or less.

According to one embodiment, the weights associated with different classes of users and/or individual users of the network are taken from the services node configuration and sent to a radio node when it is provisioned. This provisioning information is sent to the downlink scheduler, where it is used to drive the operation of the scheduler. In one example, the radio network comprises a high speed uplink packet access (HSUPA) scheduler. In this embodiment, the weights associated with different user classes and/or individual users of the network are communicated between the services and radio nodes to enable the apportionment of service among the users. In another example, the radio network comprises a high speed downlink packet access (HSDPA) scheduler and the weights associated with different user classes are communicated between the services and radio nodes within the network. In one specific example, two signals are communicated between the services node and the radio nodes. First signal includes the weights associated with the class of users or individual users of the network. The communicated weights enable the uplink and downlink schedulers to appropriately partition the airlink resources. In one example, the first signal is communicated using a shared channel configuration message when a radio node is provisioned. The configuration of the radio node may be further updated using the same communication mechanism, if and when, new weight assignments are provided. The second signal that is communicated between the services and radio nodes comprises the (default) CoS associated with each user. This signal can be communicated in a radio link configuration message when a link is established on a radio node for a particular user. The communication of the second signal may be carried out using two separate radio link configuration messages (i.e., one for downlink and one for uplink) or using a single radio link configuration messages for both the downlink and the uplink channels.

As noted earlier, variations of the above-noted embodiments allow the communication of messages, including the resource allocation weights, without the presence of a centralized controller. Further, while the above embodiments have been described in the context of an exemplary UMTS system, the disclosed embodiments may be extended to operate with other systems and networks such as CDMA200, WiMAX, LTE and the like.

In a further embodiment, the maximum rate limits are imposed one or more of the user classes. For example, using CLI and/or TR clients, an operator can set a maximum downlink data rate for PS sessions associated with the guest users. This maximum limit may be specified, for example, in terms of a maximum bit rate (e.g., 5 Mega bits per second) that is applied to each guest user. Therefore, aside from setting specific resource partitioning weights to various user types, maximum downlink rate limits may also be implemented. In one example, the resource portioning that is carried out during operation of the network may override the maximum rate limits. In another variation, an overall rate limit is applied to all guest users or a subset of all guest users. In yet another variation, limits are imposed on a specific type of traffic associated with a user or a group of users within a class. For example, a rate limit can be applied only to bit torrent portion of the traffic associated with a guest user but not to other types of traffic of the guest user. Another example includes applying a first rate limit to the bit torrent traffic and a second rate limit to the other traffic associated with the guest user. The above scenarios only provide a few example implementations of rate limits. However, it is understood that other variations of the above-noted examples can be implemented to allow the imposition of one or more rate limits to one or more users of the network.

Similarly, a maximum uplink rate may be imposed on one or more users and/or user classes of the network. For example, through a CLI and/or a TR client, the operator may set the maximum uplink rate associated with guest user PS sessions. This maximum rate may also be specified in terms of a bit rate. Similar to the downlink scenario, the uplink maximum rates may be imposed in addition to the specific resource partitioning associated with the users. The resource portioning that is carried out during operation of the network may, however, override the uplink maximum rate limits. Further, the maximum uplink rates may be superseded by uplink rise-over-thermal (ROT) noise or interference considerations.

The maximum rate control may also be applied to the authorized user traffic, or generally to the traffic associated with any one of the plurality of classes in both the downlink and uplink directions. Further differentiation may be applied within each class. For example, different maximum rates may be imposed on different authorized users and/or groups of authorized users. It should be also noted that maximum settings can be imposed on other resources, as well. For example, maximum limits may be imposed on a class of users' utilization of power or time intervals.

In one embodiment, the enforcement of maximum resource limitation for downlink transmissions may be effected at the services node. As a result, in this embodiment, maximum rate enforcement at the radio node (e.g., at the downlink airlink scheduler) is not needed and the data that resides in the downlink airlink queues already satisfies the downlink maximum resource usage limitations. As to the uplink transmissions, the maximum resource limitations may be enforced at the services node. However, in a different embodiment, maximum resource limitations may be enforced at the uplink airlink scheduler, thereby preventing the consumption of precious airlink resources for transmission of data that is going to be dropped the services node.

In the following examples, the various embodiments are described in the context of High Speed Packet Access (HSPA), and in particular, in the context of uplink and downlink schedulers that are implemented as part of a HSPA protocol. HSPA is a protocol used within Wideband Code Division Multiple Access (WCDMA) and it comprises two mobile telephony protocols: High Speed Downlink Packet Access (HSDPA) and High Speed Uplink Packet Access (HSUPA). HSPDA and HSUPA extend and improve the performance of existing WCDMA protocols by improving the capacity and throughput while reducing latency. HSPA increases peak data rates and capacity in several ways. For example, shared-channel transmission is used, which results in efficient use of available code and power resources in WCDMA. In addition, a shorter transmission time interval (TTI) reduces round-trip time and improves the tracking of fast channel variations. Utilization of a Hybrid ARQ (HARQ) with incremental redundancy also makes retransmissions more effective. Link adaptation in HSPA further maximizes channel usage and enables the base station to operate close to maximum cell power. Fast scheduling is another feature of HSPA, which prioritizes users with the most favorable channel conditions.

The examples that follow are included to facilitate the understanding of the disclosed principles but are not intended to limit the scope of the various embodiments. These examples correspond to particular implementations of the HSPA scheduling operations. In one example, one HSDPA queue per TTI is implemented in the downlink in conjunction with one large uplink transmission for HSUPA at any time. In this example, different TTIs are provided for different user equipment types in HSUPA. Analogous and extended methods can be applied to other air-interface standards such as CDMA2000, LTE or WiMAX, and to HSPA where multiple queues may be served at the same time. For example, multiple queues may be served at the same time by using various physical layer channelization methods, such as CDMA, OFDM, or FDMA.

Part of the HSPDA scheduler task comprises scheduling transmission of user data based on information such as channel quality information (CQI) for each active user equipment (UE), queue dynamics such as buffer occupancy and buffer flow, and the like. In some embodiments, the following priority scheduling hierarchy is applied by the HSDPA scheduler: (1) the highest priority is given to traffic of any type that requires HARQ retransmission, and (2) the second highest priority is provided to data traffic based on user classification (e.g., authorized versus guest user classification). In other embodiments, different priority structures may be implemented. For example, in one variation, voice traffic data may be prioritized separately (e.g., as having the highest level priority).

The HSDPA scheduler can serve users by utilizing any one of a number of different scheduling methods. By the way of example, and not by limitation, these scheduling methods include a round robin method, a proportional fair method, a weighted fair queuing method, a longest head-of-line latency method and an earliest-deadline-first method. In the proportional fair method, the scheduling is carried out in accordance with one or more fairness metrics that typically provide signaling information to users in a manner that is inversely proportional to the anticipated resource consumption for that user. In some embodiments, the proportional fair method, when used for scheduling one type of traffic (e.g., voice data), keeps the proportional fair metrics isolated from any metrics that may be used in scheduling other types of traffic. In such embodiments, service to each type of traffic queue does not impact the metrics associated with other types of traffic queues for the same user. Proportional fair scheduling strives to balance data service across users with time-varying channels. In this context, the higher priority traffic simply reduces the air-interface resources available to be shared among data service users.

While the implementation of a proportional fair scheduling method may constitute a viable solution, it may not be needed for low volume traffic and/or traffic that requires low latency. For similar reasons, differentiation between different user classes (e.g., authorized versus guest users) is not likely to be needed for such low volume and/or low latency traffic. In an alternate embodiment, a round robin or a weighted round-robin scheduling method is used, where the users are served in a round-robin fashion, with possibly no regard for resource consumption.

According to another embodiment, within the priority level associated with data queues for different user classes, the HSDPA scheduler serves the users according to another hierarchical scheme. In particular, the users are served first according to their user class categorization and then according to a proportional fair scheduling method. Further, if the users of a chosen class do not have data to be served, then a different class may be selected for service. In the example scenario, where the data queues correspond to only the authorized and guest classes of users, the first step is to determine whether to serve the authorized or guest users. Once a particular class of users is chosen, the next step is to use and update a proportional fair metric to determine the scheduling priority associated with the users within that class.

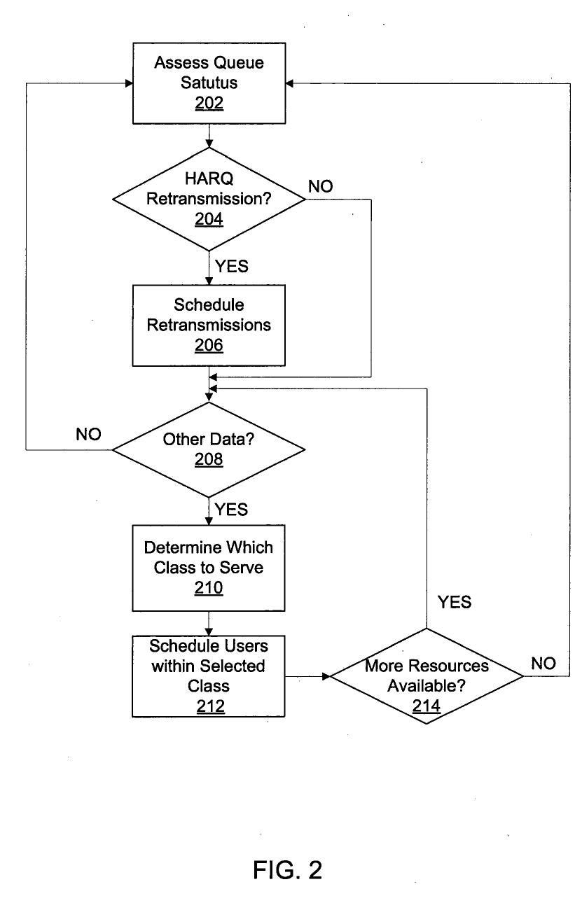

FIG. 2 is a block diagram that illustrates the scheduling of data and other information in accordance with the disclosed embodiments. While FIG. 2 illustrates the operations in the context of a two-level priority structure (i.e., HARQ retransmissions and other data) it is understood that the disclosed operations can be readily extended to accommodate different priority structures with fewer or additional levels. For example, voice data may be included in the diagram of FIG. 2 as having a separate priority level than HARQ retransmissions and other data. It should also be noted that the exemplary steps that are illustrated in FIG. 2 are applicable to situations where a single air-interface standard (e.g., HSPA) is used, to situations where multiple air-interface standards such as CDMA2000, LTE or WiMAX, HSPA and the like are used, as well as to situations where single or multiple queues are served at the same time. Thus, the operations that are illustrated in FIG. 2 can be used to effect scheduling multiple queues, users and/or traffic types, all at the same time.

In step 202 of FIG. 2, the status of various queues are assessed. This assessment allows a scheduler to determine the types of data and information within the queues, the number of queues and other information associated with the queues. In step 204, it is determined if any of the queues comprises HARQ retransmission data. If there are queues with HARQ retransmission data (i.e. “YES”), the data associated with HARQ retransmissions is scheduled to be transmitted to the users in step 206. As noted earlier, HARQ retransmissions have the highest priority. If, on the other hand, the queues do not contain HARQ retransmission data (i.e., “NO”) and/or HRAQ retransmission scheduling has already taken place, the process continues to step 208, where a determination is made as to whether the queues comprise data associated with users. If, in step 208 the determination is made that no other data is present in the queues (“NO”), the process returns to step 202 to further assess the status of the queues. If, on the other hand, queues with other data are present (“YES”), it is determined, in step 210, which class or classes of users are to be served. In step 212, the data associated with the class or classes of users selected in step 210 is scheduled for transmission to the users. For example, in step 212, a proportional fair scheduling scheme may be used for scheduling the particular users within the selected class. Upon scheduling the resources for the users with the selected group, it is determined, in step 214, whether or not additional resources are available. If the answer is “YES,” steps 208 to 212 are repeated to allocate resources to additional user classes. If the answer is “NO,” the process returns to step 202 awaiting the next round of queue assessment.

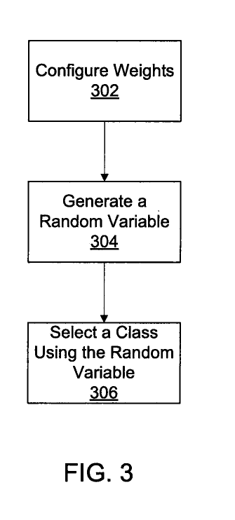

The following example describes a method for selecting a particular class of users in accordance with the disclosed embodiments. This exemplary method can be used in step 210 of FIG. 2. It should be noted, however, that other selection methods may be implemented to carry enable the selection of the particular users and/or user classes. In general, the users can be partitioned into N different classes. FIG. 3 is a block diagram that illustrates the various steps associated with the selection of a particular user class according to this example embodiment. In step 302, weights, wᵢ, are configured for each class i, where i=2, 3, . . . N. In step 304, which can be carried out at the time of scheduling decision, a random variable, r, is generated. The random variable can be, for example, a uniformly distributed discrete random variable in the range 0 to 1. In step 306, the random variable is used to select one of N classes of users. For example, a probability distribution can be calculated according to Equation (1):

$${P}_{i} = \frac{{w}_{i}}{{\sum }_{j = 1}^{N} {w}_{j}} . \qquad ( 1 )$$

In Equation (1), Pᵢ is the probability associated with a particular user class, i, and wᵢ represents a weight associated with user class i. The random variable can be used to select one of the N classes of users. It should be noted that a random selection of a particular user class is made only if the queue data corresponds to at least two classes of users with at least one user in each class of users. In the scenario where only two classes of users are present (e.g., authorized and guest users), the probability associated with the authorized users can be calculated according to Equation (2).

$${P}_{1} = \frac{{w}_{1}}{{w}_{1} + {w}_{2}} . \qquad ( 2 )$$

In the example scenario, where N=2 and P₁=0.75, if the random variable, r, falls in the range 0 to 0.75, class 1 is selected, otherwise, class 2 is selected.

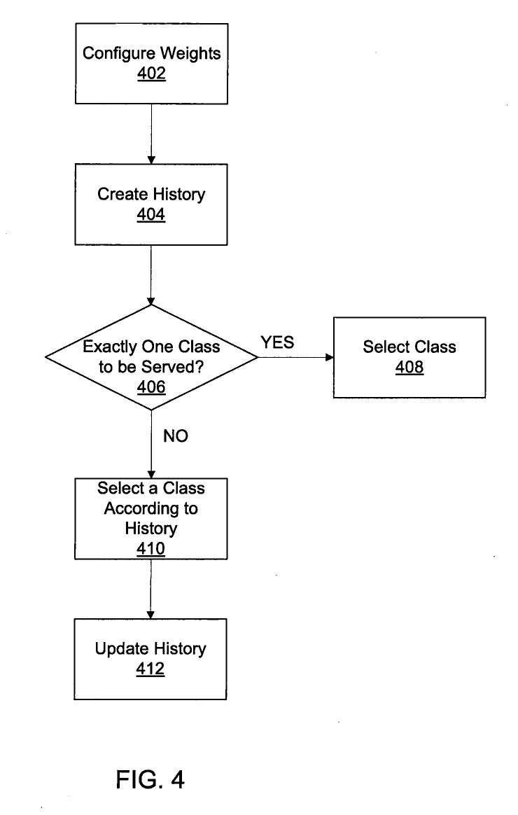

FIG. 4 is a block diagram that illustrates the various steps associated with the selection of a particular user class according to another exemplary method. In step 402, weights, wᵢ, are configured for each class i, where i=2, 3, . . . N. The configuration of step 402 may also comprise converting the weights to percentages. This conversion can be done, for example, according to Equation (1). In step 404, a history of conditional access decisions associated with each class of users is created. Such a history keeps track of the last M selections of the user classes. In one example, where M is equal to 500, the last 500 decisions associated with each user class are recorded in a circular buffer of size 500. The buffer can be managed using an index that is incremented every time a user class is selected. Note that in HSDPA with a TTI of 2 msec, 500 decisions spans a 1-second time period. For each class of users, a count value, cᵢ, can also be maintained to keep track of the number of times a particular user group has been selected (e.g., 0≦cᵢ≦500).

In step 406, it is determined if there is only one class to be served. If the answer is “YES,” that class is selected in step 408, without referencing or updating the selection history. Similarly, the history is not referenced or updated (in fact, no action is taken) if the data queues are empty (e.g., for a particular TTI). If there are more than one class of users are present (i.e., “NO”), a particular class is selected in step 410. This selection is carried out using the recorded history. In one example, a particular class, i, with the smallest cᵢ-to-wᵢ ratio is selected. In step 412, the history is updated based on the selection of the user class in step 410. For example, if a particular class, i, is selected, the associated count, cᵢ, is incremented and the history buffer is updated with a ‘1’ value at the current index location. Further, for each user class that had queue data traffic but was not selected, a ‘0’ value is entered at current index location. For each class, i, that had no traffic, the history buffer is marked with a ‘1’ value according to a probability Pᵢ. For example, Pᵢ relate to the configured weights, wᵢ, that was described in step 402. Step 408 further comprises incrementing the index value modulo M.

In other embodiments, the selection of a particular class can be accomplished using a deterministic method that computes a schedule for selecting particular classes one after the other. Further, such a method guarantees that the delay between two successive services of a particular class (e.g., as a function of the class weights) conforms to particular values or patterns. In one example, the selection of classes is guaranteed to exhibit a uniform (or substantially uniform) behavior so that a particular class does not have to wait too long before it is served again.

The disclosed embodiments also facilitate the operations of the uplink scheduler based on a conditional access paradigm. HSUPA scheduler operates on a request-grant principle, in which the scheduler determines the timing and the number of grants that are to be assigned in response to the requests for resources. According to the disclosed embodiments, a similar priority paradigm as the one discussed in connection with the downlink scheduler may be utilized with the uplink scheduler. In one example, categorization of users into several classes (e.g., authorized and guest users, etc.) is indicated as part of the radio link configuration. Similar to the methodology described in connection with the downlink scheduler, a particular class can be selected according to a probability value. For example, the probability value can be calculated according to Equation (1). If only two classes of users exist (e.g., authorized and guest user classes), the probability of selecting the authorized user class can be calculated from Equation (2). If no user in the chosen class has any traffic, then users from the other classes are considered for allocation.

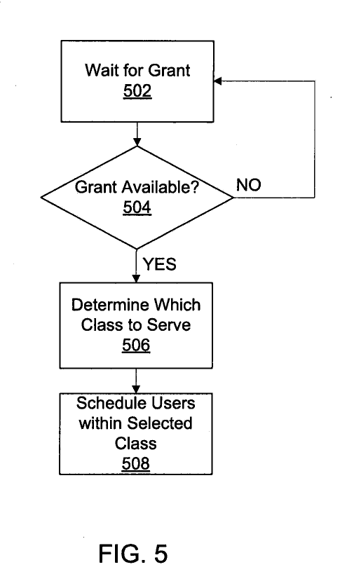

FIG. 5 is a block diagram that illustrates the scheduling of data transmissions by an uplink scheduler in accordance with an exemplary embodiment. In this embodiment, the uplink scheduler assigns a grant to a user in any TTI. In step 502, the scheduler waits for a grant to become available. The availability of the grant may depend on other types of traffic with higher priority. For example, HARQ signals may take a higher priority than the traffic data. If, in step 504, the determination is made that a grant is not available (“NO”), the process returns to step 502 to wait for a grant. If, on the other hand, the determination if made that a grant is available (“YES”), the process continues to step 506, where it is determined which class of users are to be served. This determination can be done based on, for example, a probability value that is associated with each of N different classes of users. In step 508, the users within the selected class are scheduled with grant. For example, a user with the longest wait time may be selected. In other embodiments, a grant may be terminated in favor of another “higher priority” user. For example, if there is no data associated with a high-priority authorized user, a grant may be allocated to guest user. However, if the scheduler is subsequently informed that an authorized user requires service, the scheduler may terminate the grant associated with the guest user and allocate the necessary resources to accommodate the needs of the authorized user.

As noted earlier, in some embodiments, the scheduling and transmission of data is carried out in accordance with weights that are assigned to individual users and/or groups of users within a user class. In these scenarios, the various steps that are illustrated in FIGS. 2 through 5 may be adjusted to accommodate such alternate embodiments. For example, steps 210, 306, 410 and 506, in FIGS. 2, 3, 4 and 5, respectively, may be modified to enable the selection of a user or group of users rather than a class of users.

While the foregoing description has been described in the context of allocation of specific resources for the purpose of illustration, the disclosed embodiments can be applied to effect admission control to a radio network that is based on the disclosed conditional access principle. For example, in reference to FIG. 1, an admission control module that resides on a services node 104 can be configured to deny or allow access to the network according to a multi-tier user classification. For example, admission of additional users may be controlled based on the number existing users of the radio network in each class and/or the weights assigned to the existing users of the radio network.

In another variation, the classification of users and subsequent allocation of resources can be carried out according to additional factors. In one example, location of a user can be used as an additional factor for effecting conditional access. For instance, a user may be categorized as an employee of an enterprise and, therefore, be given preferential classification. However, if the user is located at the periphery of the network (e.g., a corner office), the user's network access may be hampered by guest or roaming users' attempts to acquire network access. In such a scenario, the user's existing weight assignment may be modified to allow utilization of even a larger portion of the network resources. In a different scenario, where the network is attempting to fill-in a coverage hole within a larger macrocellular network, the reverse policy may be implemented. As such, according to the disclosed embodiments, the authorized and/or guest user weight assignments (and thus the corresponding resource allocations) may be modified for one or more radio nodes based on the location of the particular user(s) of interest. In the scenario where a radio node is used (at least in part) to fill-in a coverage hole in the larger macro network, the existing weight associated with an authorized user in the area covered by that particular radio node may be decreased relative to the guest user class. In such case, a greater set of resources are allocated to the guest user class for that particular radio node at the expense of the authorized user(s). In a reverse scenario, the weight(s) associated with one or more authorized users of a particular node and/or within a particular geographic location can be increased to accommodate the needs of the authorized user(s). In other embodiments, the weights associated with a particular class of users, rather than weights associated with individual users, can be modified on a per-radio-node basis to accommodate the needs of a particular user class or individuals within each user class. For instance, in the context where an authorized user's network access is hampered by guest or roaming users' attempts to acquire network access, the weight associated with the authorized user class may be increased relative to the weight associated with the guest user class for one or more radio nodes of interest. Analogously, in the context where the network is attempting to fill-in a coverage hole within a larger macrocellular network, the weight associated with the authorized user class may be decreased relative to the weight associated with the guest user class for one or more radio nodes of interest. This way, when an authorized user (or a guest user) moves from one radio node to another, that user's classification remains the same but the weight assigned to the user's class may change as that user changes serving radio nodes.

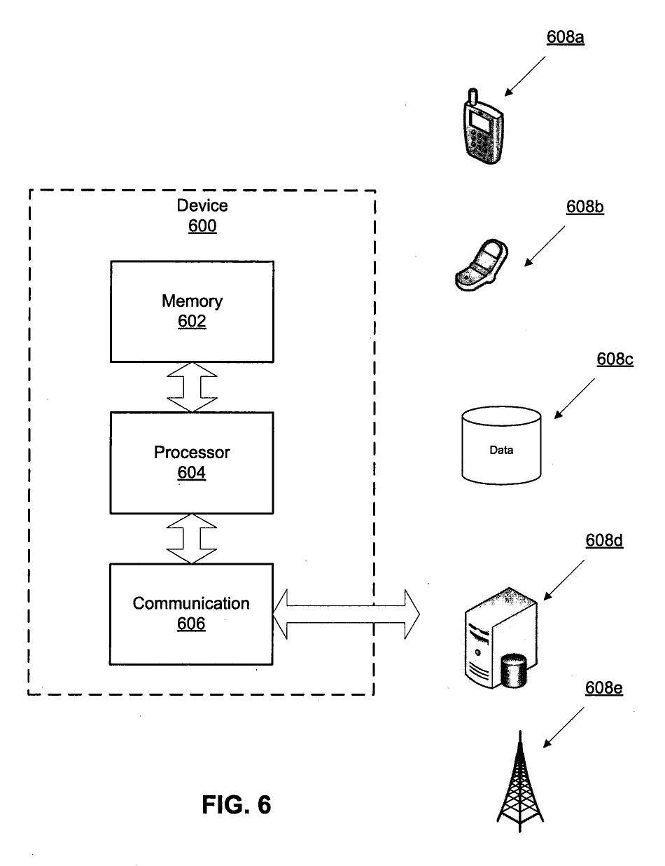

It is understood that the various embodiments of the present invention may be implemented individually, or collectively, in devices comprised of various hardware and/or software modules and components. These devices, for example, may comprise a processor, a memory unit, an interface that are communicatively connected to each other, and may range from desktop and/or laptop computers, to consumer electronic devices such as media players, mobile devices and the like. For example, FIG. 6 illustrates a block diagram of a device 600 within which the various embodiments of the present invention may be implemented. The device 600 comprises at least one processor 602 and/or controller, at least one memory 604 unit that is in communication with the processor 602, and at least one communication unit 606 that enables the exchange of data and information, directly or indirectly, with other entities, devices and networks 608a to 608e. The communication unit 606 may provide wired and/or wireless communication capabilities in accordance with one or more communication protocols, and therefore it may comprise the proper transmitter/receiver antennas, circuitry and ports, as well as the encoding/decoding capabilities that may be necessary for proper transmission and/or reception of data and other information. The exemplary device 600 that is depicted in FIG. 6 may be integrated into a services node 104 and/or radio nodes 16 a to 106c that are illustrated in FIG. 1. The device 600 that is depicted in FIG. 6 may reside as a separate component within or outside services node 104 and/or radio nodes 16 a to 106c a radio network.

Similarly, the various components or sub-components within each module of the present invention may be implemented in software, hardware, firmware. The connectivity between the modules and/or components within the modules may be provided using any one of the connectivity methods and media that is known in the art, including, but not limited to, communications over the Internet, wired, or wireless networks using the appropriate protocols.

Various embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the disclosed embodiments can be implemented as computer program products that reside on a non-transitory computer-readable medium. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method, comprising:
assigning weights to a plurality users of a radio network, each of the plurality of users being categorized within one of a plurality of classes;
allocating radio network resources to a user pursuant to the weight associated with the user.

2. The method of claim 1, wherein
the radio network is configured within a larger radio network;
the plurality of users comprise one or more users of the larger radio network that are unknown to the radio network; and
the one or more users of the larger radio network request one or more services from the radio network.

3. The method of claim 1, wherein the plurality of classes comprise an authorized class of users with a preferential level of radio network service.

4. The method of claim 3, wherein a user within the authorized class of users is identified in accordance with an identifier within an internet protocol (IP) packet associated with the user within the authorized class of users.

5. The method of claim 1, wherein the plurality of classes comprise a guest class of users with a conditional level of radio network service.

6. The method of claim 1, wherein a weight is assigned to each individual user of the radio network.

7. The method of claim 1, wherein a weight is assigned to each group of users of the radio network within a particular class.

8. The method of claim 1, wherein a weight is assigned to each class of users of the radio network.

9. The method of claim 1, wherein radio network resources are allocated in proportion to the assigned weights.

10. The method of claim 1, wherein the radio network resources comprise a bandwidth, a time slot, a carrier frequency or a transmission power associated with the radio network.

11. The method of claim 1, wherein the allocating comprises:
selecting a class of users; and
allocating radio network resources to a plurality of users within the selected class.

12. The method of claim 11, wherein the selecting is carried out in accordance with a probability value.

13. The method of claim 11, wherein the selecting is carried out deterministically in accordance with a number of user classes and weights associated with the plurality of user classes.

14. The method of claim 11, wherein the selecting is carried out in accordance with a history of previously selected user classes.

15. The method of claim 11, further comprising:
determining if additional radio network resources are available;
selecting a different class of users; and
allocating radio network resources to a plurality of users within the different class of users.

16. The method of claim 1, further comprising:
setting a maximum level of radio network resources consumed by at least one user of the radio network.

17. The method of claim 16, wherein the maximum level of radio network resources comprises a maximum data rate.

18. The method of claim 1, further comprising controlling admission to the radio network pursuant to the assigned weights.

19. The method of claim 1, further comprising modifying an allocated radio network resource to an authorized user by changing a weight associated with the authorized user when the authorized user is in communication with one or more radio nodes.

20. The method of claim 1, further comprising modifying, on a per-radio-node basis, an allocated radio network resource to a particular class of users by changing a weight associated with the particular class of users when the particular class of users are communicating through one or more radio nodes.

21. The method of claim 20, wherein the one or more radio nodes designate a particular geographic location.

22. The method of claim 1, where allocating the radio network resources is carried out pursuant to the number of additional users within the radio network.

23. The method of claim 16, wherein the user is an authorized user of the radio network and the additional users are guest users of the radio network.

24. The method of claim 1, further comprising
configuring a list of users associated with at least one of the plurality of classes, wherein a user within the configured list is identified in accordance with a unique identifier.

25. The method of claim 24, wherein the unique identifier is an international mobile subscriber identity (IMSI).

26. A device, comprising:
a processor; and
a memory comprising processor executable code, the processor executable code, when executed by the processor, configures the apparatus to:
assign weights to a plurality users of a radio network, each of the plurality of users being categorized within one of a plurality;
allocate radio network resources to a user pursuant to the weight associated with the user.

27. A computer program product, embodied on a computer readable medium, comprising:
program code for assigning weights to a plurality users of a radio network, each of the plurality of users being categorized within one of a plurality of classes;
program code for allocating radio network resources to a user pursuant to the weight associated with the user.
